(19) United States
(12) Patent Application Publication
(10) Pub. No.: US 2011/0122133 A1
(43) Pub. Date: May 26, 2011

(54) METHOD AND PROGRAM FOR CONSTRUCTING THREE DIMENSIONAL OBJECT MODEL

(75) Inventors: Hiroshi SANKOH, Saitama (JP); Sei NAITO, Saitama (JP); Shigeyuki SAKAZAWA, Saitama (JP)

(73) Assignee: KDDI CORPORATION, TOKYO (JP)

(21) Appl. No.: 12/951,479

(22) Filed: Nov. 22, 2010

(30) Foreign Application Priority Data
Nov. 25, 2009 (JP) 2009-267302
Jun. 15, 2010 (JP) 2010-135873

(51) Int. Cl. G06T 17/00

(52) U.S. Cl. 345/424

(57) ABSTRACT

A present invention provides a method for constructing a highly accurate visual hull from multi view point images without highly accurate silhouettes. A method of the present invention comprises calculating continuous values to represent background likelihood of each pixel for every object image based on pixel values of said object images and those of said background images, calculating the projection pixels for each voxel at every captured view point by projecting each voxel in voxel space on each captured view point of said object images, and determining an object domain with judging whether said voxel belongs to the object domain or not based on the continuous value of said pixel at every captured view point.

### PRIORITY CLAIM

This application claims priority from Japanese patent applications No. 2009-267302, filed on Nov. 25, 2009 and No. 2010-135873 filed on Jun. 15, 2010, which are incorporated herein by reference.

### BACKGROUND OF THE INVENTION

1. Field of the Invention

The present invention relates to a method and a program for constructing a three dimensional object model from object images that an object is captured and background images that only a background is captured.

2. Description of the Related Art

As typical technique to construct a three dimensional object model (a three dimensional voxel data) from multi view point images, there is a shape from silhouette method (Toyoura et al “3D Shape Reconstruction from Incomplete Silhouettes in Time Sequences”, PRMU2007-168, Vol. 107, No. 427, pp. 69-74, 2008-1) which reconstructs a visual hull as a three dimensional object model. This method has a problem that an accuracy of the visual hull is greatly influenced by an accuracy of silhouette extracted at each view point. For this reason, in order to construct highly accurate visual hull, it was necessary to extract a highly accurate silhouette and special environment such as a blue back was necessary. Japanese patent publication No. 2007-17364 and Toyoura et al “Silhouette Refinement for Visual Hull with Random Pattern Background”, the 2005 IEICE General Conference, D-12-133 describe a method for improving accuracy of the silhouette, the method repairs a deficit of the silhouette in a background subtraction using color information of each voxel in three dimensional voxel space.

### BRIEF SUMMARY OF THE INVENTION

A conventional method firstly needed a sufficiently highly accurate silhouette in order to construct highly accurate visual hull. Therefore, there was a problem to have to extract the highly accurate silhouette with complicatedly calculating and using manual labor or special photography environment such as the blue back.

Thus, as for the conventional shape form silhouette method, there is the problem that the accuracy of the visual hull is greatly influenced by the accuracy of silhouette extracted at each view point. In particular, the problem called “deficit”, that the domain which is originally an object domain is classified as a background in the silhouette by mistake, was fatal in the accuracy of the Visual Hull.

Therefore, it is an purpose of a present invention to provide a method and a program for constructing a highly accurate visual hull from multi view point images without highly accurate silhouettes.

To realize the above purpose, according to a method for constructing a visual hull of the present invention, a method for constructing the visual hull from a number of object images that an object and a background are captured and a number of background images that only a background is captured, the method comprises: a first calculation step of calculating continuous values to represent background likelihood of each pixel for every object image based on pixel values of said object images and those of said background images; a second calculation step of calculating the projection pixels for each voxel at every captured view point by projecting each voxel in voxel space on each captured view point of said object images; and a determination step of determining an object domain with judging whether said voxel belongs to the object domain or not based on the continuous value of said pixel at every captured view point.

Further, it is also preferable that said first calculation step is a step of calculating averages and dispersions of each pixel of said background images; and calculating the background likelihood of each pixel of said object image based on said averages and said dispersions, by assuming the background likelihood of said background images to be an normal distribution.

Further, it is also preferable that said determination step is a step of calculating an average of the background likelihood of each voxel based on the averages of the background likelihoods of the pixels at every captured view point; and determining that said pixel belongs to the object domain when the average is smaller than a certain threshold and that said pixel does not belong to the object domain when the average is equal to or larger than the certain threshold.

Further, it is also preferable that the pixel values of said object images and the pixel values of said background images are represented as a three dimensional vector of HSV space.

To realize the above purpose, according to a non-transitory computer readable storage medium for constructing a visual hull of the present invention, a non-transitory computer readable storage medium encoded with a computer readable program configured to cause a computer to execute a method for constructing a visual hull from a number of object images that an object and a background are captured and a number of background images that only a background is captured, the method comprising: a first calculation step of calculating continuous values to represent a background likelihood of each pixel for every object image based on pixel values of said object images and those of said background images; a second calculation step of calculating the projection pixels for each voxel at every captured view point by projecting each voxel in voxel space on each captured view point of said object images; and a determination step of determining an object domain with judging whether said voxel belongs to the object domain or not based on the continuous value of said pixel at every captured view point.

According to the method to represent each voxel with the continuous values based on the background likelihood of the present invention, the method can utilize various mathematical frames in comparison with the conventional method represented only with the two level of a foreground or a background, can construct the higher accurate visual hull.

### BRIEF DESCRIPTION OF THE SEVERAL VIEWS OF THE DRAWINGS

FIG. 1 shows a flow chart showing a method for constructing a visual hull of the present invention,

FIGS. 2a and 2b show a silhouette determined an object domain and a background domain with a certain threshold,

FIG. 3 shows a visual hull obtained from the background likelihood viewed from the lateral direction,

FIG. 4 shows a visual hull obtained from the background likelihood viewed from the vertical direction, and

FIG. 5 shows a visual hull obtained from the background likelihood viewed from the front direction.

### DETAILED DESCRIPTION OF THE INVENTION

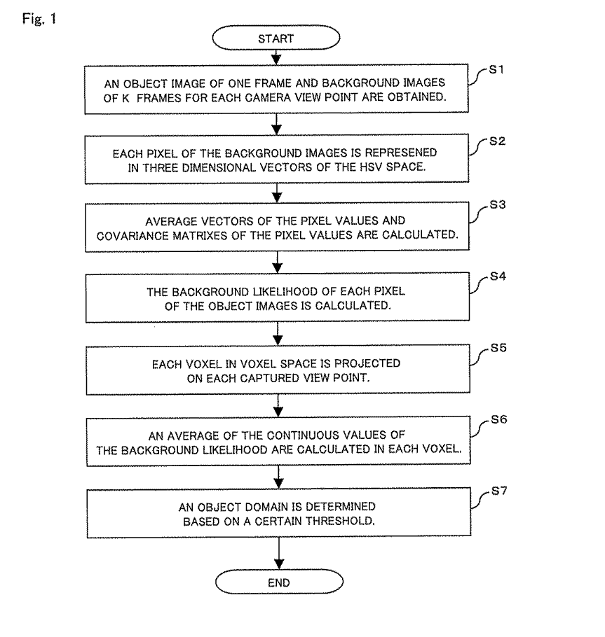

An embodiment of a method and a program for constructing a visual hull will be described below with reference to the drawings. FIG. 1 shows a flow chart showing a method for constructing a visual hull of the present invention. The embodiment will be described below with reference to the flow chart.

Since the conventional shape from silhouette method treats each pixel of the object silhouette in each captured view point with the two level of a foreground or a background, the accuracy of the visual hull deteriorates, when it is classified mistakenly. Therefore, the present invention represents an object silhouette with a continuous values based on a background likelihood, by calculating an average of a projection pixel in each view point about each voxel. Finally, the present invention determines an object domain based on the background likelihood of each voxel, and constructs the visual hull.

Step 1: An object image of one frame and background images of K (k=1−K) frames for each camera view point are obtained. A number of calibrated cameras are placed in the circle, and the object images including the object and the background and the background images only including the background are captured with said camera. It is assumed that each is captured I pieces (i=1−I), respectively. For example, when 30 cameras are placed and background images for 60 frames are used, the object images are obtained 30 pieces and the background images are obtained 30*60 pieces, respectively.

Step 2: Each pixel of I*K pieces of the captured background images is represented in three dimensional vectors of the HSV space. The HSV space is the space that color information is represented three components of a hue (H), a saturation (S), a value (V). It is assumed that the pixels of the background images were J units (j=1−J). For example, when the size of the background images is 1,280*720, J=1,280*720. In this way, each pixel of I*K pieces of captured background images is represented in the three dimensional vectors of the I*J*K units,

x^{(k)}ᵢⱼ=(x_{H}_{^{(k)}}ᵢⱼ,x_{S}_{^{(k)}}ᵢⱼ,x_{V}_{^{(k)}}ᵢⱼ)(i=1, . . . ,I;j=1, . . . ,J;k=1, . . . K) (1).

Step 3: Average vectors uᵢⱼ of the pixel values and covariance matrixes Sᵢⱼ of the pixel values are calculated, by taking the average and the dispersion of each pixel for every view point using K pieces background frames.

The average vectors uᵢⱼ of the pixel values are calculated from

$$\begin{matrix}{u}_{ij} = ( {u}_{{Hi}_{j}} , {u}_{{S}_{ij}} , {u}_{{V}_{ij}} ) \\ = ( \frac{1}{K} {\sum }_{k = 1}^{K} {x}_{{H}^{{( k )}_{ij}}} , \frac{1}{K} {\sum }_{k = 1}^{n} {x}_{{S}^{{( k )}_{ij}}} , \frac{1}{K} {\sum }_{k = 1}^{K} {x}_{{V}^{{( k )}_{ij}}} ) ,\end{matrix} \\ ( i = 1 , … , I , j = 1 , … , J , k = 1 , … K ) . \qquad ( 2 )$$

Also, the covariance matrixes Sᵢⱼ of the pixel values are calculated from

$${S}_{ij} = ( \begin{matrix}{σ}_{{H}_{ij} {H}_{ij}} & {σ}_{{H}_{ij} {S}_{ij}} & {σ}_{{H}_{ij} {V}_{ij}} \\ {σ}_{{S}_{ij} {H}_{ij}} & {σ}_{{S}_{ij} {S}_{ij}} & {σ}_{{S}_{ij} {V}_{ij}} \\ {σ}_{{V}_{ij} {H}_{ij}} & {σ}_{{V}_{ij} {S}_{ij}} & {σ}_{{V}_{ij} {V}_{ij}}\end{matrix} ) , ( i = 1 , … , I , j = 1 , … , J ) . \qquad ( 3 )$$

Note that, the component of the first row and the second column is represented as

$${σ}_{{H}_{ij} {S}_{ij}} = {\sum }_{k = 1}^{K} \frac{1}{K} ( {x}_{{H}^{{( k )}_{ij}}} - {u}_{{H}_{ij}} ) ( {x}_{{S}^{{( k )}_{ij}}} - {u}_{{S}_{ij}} ) \\ ( i = 1 , … , I , j = 1 , … , J , k = 1 , … K ) . \qquad ( 4 )$$

The other components are represented as the same manner.

Step 4: The background likelihood (a background-ness) of each pixel of the object images is calculated. Each pixel of the I pieces of the captured object images is represented in the three dimensional vectors of the I*J unit,

x′ᵢⱼ=(x′_{H}_{^{ij}},x′_{S}_{^{ij}},x′_{V}_{^{ij}}),(i=1, . . . ,I,j=1, . . . ,J) (5)

as well as the background images. The continuous values to represent the background likelihood in each pixel, supposing that the form is a Gaussian distribution (an normal distribution), are represented,

$$f ( {x}_{ij}^{′} ; {u}_{ij} , {S}_{ij} ) = \frac{1}{{( 2 π )}^{3 / 2} {\vert {S}_{ij} \vert}^{1 / 2}} exp ( - 1 / 2 {( {x}_{ij}^{′} - {u}_{ij} )}^{T} {S}_{ij}^{- 1} ( {x}_{ij}^{′} - {u}_{ij} ) ) , \\ ( i = 1 , … , I , j = 1 , … , J ) . \qquad ( 6 )$$

This continuous values are within 0<f(x′)<=1, and represent the probability that the pixel is the background. The probability that the pixel is the background becomes large so that this continuous values near 1. Note that, here, |Sᵢⱼ| represents a determinant of matrix of Sᵢⱼ, Sᵢⱼ⁻¹ represents an inverse matrix of the matrix Sᵢⱼ, ^{T} represents the dislocation of the vector.

Step 5: Each voxel v (a point of the three dimensional space) in voxel space is projected on each captured view point. Thereby, pixels x′_{i,v(i)} (i=1−I) of the object images corresponding to the voxel are obtained I units. The v(i) is a number to specify the pixel which voxel v is projected in the i-th object image, it is decided by v and i, and is between 1−J.

Step 6: An average U of the continuous values of the background likelihood are calculated in each voxel. The average U is obtained from

$$U = \frac{1}{I} {\sum }_{i = 1}^{I} f ( {x}_{i , v ( i )}^{′} ; {u}_{i , v ( i )} , {S}_{i , v ( i )} ) . \qquad ( 7 )$$

Step 7: An object domain is determined based on a certain threshold M. The certain threshold M is determined, U>=M: the voxel belongs to the background domain, and U<M: the voxel belongs to the object domain.

From above, it determines whether the voxel belongs to the object domain or not. Thereby, it is determined whether all points of the three dimensional space belong to the background or the object, and the visual hull is constructed.

Thus, the background likelihood is represented in continuous values, and the present invention determines the object domain. The conventional shape from silhouette method represents the background likelihood in the discrete values of 0, 1, and determines the object domain only when the value is 0 with all images. Therefore, there is the problem called “deficit” that the domain which is originally the object domain is classified as the background by mistake. According to the present invention, since the background likelihood is represented in continuous values, the problem that the object domain is classified as the background by mistake is resolved.

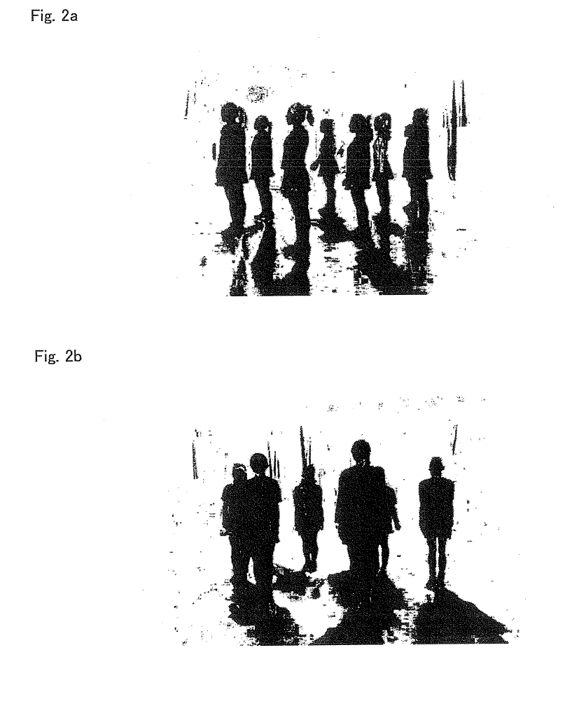

Next, the result of the present invention is shown by a real image. FIGS. 2a and 2b show the silhouette determined the object domain and the background domain with a certain threshold. FIG. 2a and FIG. 2b shows the object domain and the background domain obtained from the background likelihood, which is calculated based on formula 5 about each pixel of object images captured from different angles. In this figures, the object domain, in which the background likelihood is smaller than the threshold, is represented with black, the background domain, in which the background likelihood is equal to or larger than the threshold, is represented with white.

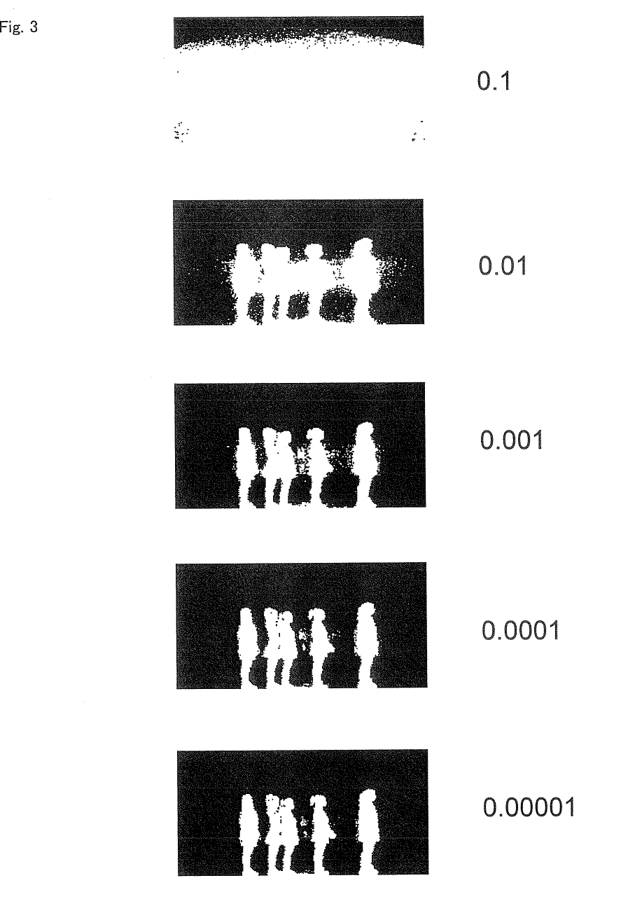

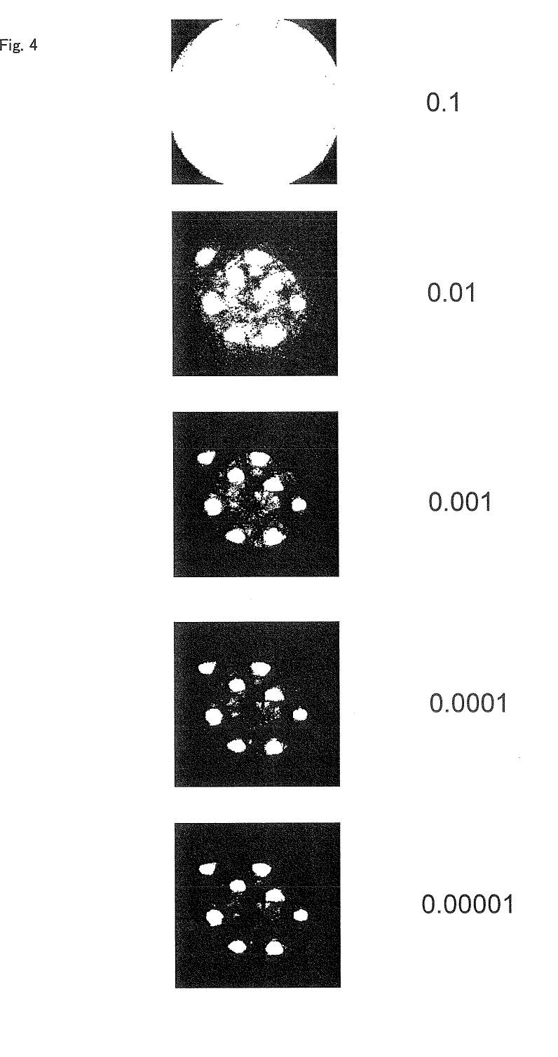

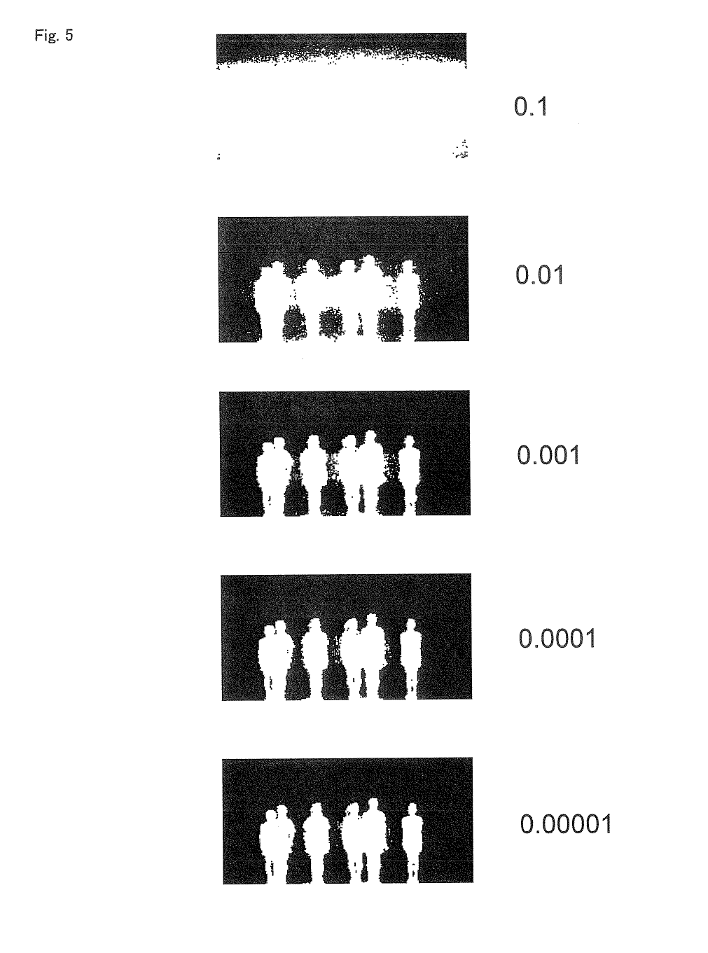

FIG. 3 shows a visual hull obtained from the background likelihood viewed from the lateral direction. FIG. 4 shows a visual hull obtained from the background likelihood viewed from the vertical direction. FIG. 5 shows a visual hull obtained from the background likelihood viewed from the front direction. In each figure, the value written to the right side is the threshold. In these figures, a white point is the object domain, in which the background likelihood is smaller than the threshold, and a black point is the background domain, in which the background likelihood is equal to or larger than the threshold. As much as the threshold is small, the voxel to belong to the object domain decreases. Thus, as much as the threshold is small, the object domain is seen clearly.

In the object silhouette of FIGS. 2a and 2b, there is “the deficit” that the domain which is originally the object domain is classified as the background by mistake (e.g. the second subject from the right of FIG. 2a). In conventional shape from silhouette method, the deficit has a large influence on the constructed visual hull. However, in the visual hull (from FIG. 3 to FIG. 5) constructed by the present invention, the influence does not extend. Thus, since the present invention represents the background likelihood with the continuous values, the problem that the object domain is classified as the background by mistake is resolve.

All the foregoing embodiments are by way of example of the present invention only and not intended to be limiting, and many widely different alternations and modifications of the present invention may be constructed without departing from the spirit and scope of the present invention. Accordingly, the present invention is limited only as defined in the following claims and equivalents thereto.

1. A method for constructing the visual hull from object images that an object and a background are captured and background images that only a background is captured, the method comprises:
a first calculation step of calculating continuous values to represent background likelihood of each pixel for every object image based on pixel values of said object images and those pixel values of said background images;
a second calculation step of calculating the projection pixels for each voxel at every captured view point by projecting each voxel in voxel space on each captured view point; and
a determination step of determining an object domain with judging whether said voxel belongs to the object domain or not based on the continuous value of said pixel at every captured view point.

2. The method for constructing the visual hull according to claim 1, wherein said first calculation step is a step of calculating averages and dispersions of each pixel of said background images, and calculating the background likelihood of each pixel of said object images based on said averages and said dispersions, by assuming the background likelihood of said background images to be an normal distribution.

3. The method for constructing the visual hull according to claim 1, wherein said determination step is a step of calculating the background likelihood of each voxel based on the averages of the background likelihoods of the pixels at every said captured view point, and determining whether said voxel belongs to the object domain or not based on the continuous value of each voxel or the correlation between said continuous value of each voxel.

4. The method for constructing the visual hull according to claim 3, wherein whether said voxel belongs to the object domain or not is determined by that said voxel does not belong to the object domain when the continuous value of the voxel is equal to or smaller than a certain threshold and that said voxel belongs to the object domain when the continuous value of the voxel is larger than the certain threshold.

5. The method for constructing the visual hull according to claim 1, wherein the pixel values of said object images and those of said background images are represented as a three dimensional vector of HSV space.

6. A non-transitory computer readable storage medium encoded with a computer readable program configured to cause a computer to execute a method for constructing a visual hull from object images that an object and a background are captured and background images that only a background is captured, the method comprising:
a first calculation step of calculating continuous values to represent a background likelihood of each pixel for every object image based on pixel values of said object images and those of said background images;
a second calculation step of calculating the projection pixels for each voxel at every captured view point by projecting each voxel in voxel space on each captured view point of said object images; and
a determination step of determining an object domain with judging whether said voxel belongs to the object domain or not based on the continuous value of said pixel at every captured view point.
